(19) United States
(12) Patent Application Publication
(10) Pub. No.: US 2024/0386342 A1
(43) Pub. Date: Nov. 21, 2024

(54) BUSINESS MENTORING PROCESS

(71) Applicant: PINNACLE GLOBAL NETWORK, INC., ENCINITAS, CA (US)

(72) Inventor: ALLISON MASLAN, ENCINITAS, CA (US)

(21) Appl. No.: 18/334,498

(22) Filed: Jun. 14, 2023

Related U.S. Application Data
(60) Provisional application No. 63/502,736, filed on May 17, 2023.

(51) Int. Cl. G06Q 10/0631; G06Q 10/0639

(52) U.S. Cl. CPC G06Q 10/063112; G06Q 10/063114; G06Q 10/06312; G06Q 10/06398

(57) ABSTRACT

A business mentoring process for managing a plurality of mentors that includes preselected process steps and metrics is described. The process includes ongoing improvement of the process by creating a database of mentor and mentee information and time based evaluation of progress of each of a plurality of mentees as they complete preselected tasks and using the evaluation to select tasks to improve other mentee performance based upon performance improvements of a first mentee. The process enables a standardization of the mentoring process.

### CROSS-REFERENCE TO RELATED APPLICATIONS

This application claims priority to U.S. Provisional application 63/502,736 titled Business Mentoring Process, filed on May 17, 2023, having the same inventor.

### STATEMENT REGARDING FEDERALLY SPONSORED RESEARCH OR DEVELOPMENT

Not Applicable.

### BACKGROUND OF THE INVENTION

### Technical Field

The invention relates to a process for managing a population of business mentors or strategic advisors and their client mentees that includes automated guiding through a pre-selected mentoring process.

### Related Background Art

Mentoring businesses, especially mentoring businesses providing strategic advise for the business' development and growth through use of strategic advisors is itself a big business category. A search for business mentor will reveal a host of companies and options for selecting mentors. The US Small business administration offers free mentorships through SCORE corporation (SCORE is a registered trademark of the Service Corp of Retired Executives AKA SCORE Corporation). The options for selecting a mentor or strategic advisor for a business however provide little or no guidance as to what the Mentor will provide. There are no standard procedures for mentoring a business owner at any phase of their business development. There is a need for a mentoring process that provides standards of performance and procedures to enable a business owner seeking a mentor's guidance to know the form of the service they will receive.

There is also no system for collection of data related to the mentoring process that includes data from a plurality of mentors, the process steps used by each and the performance results over time. There is a need for standardized process steps and performance measures that can be used to improve the business mentoring process.

Oracle, advertised as the world's largest database management company (see https://www.oracle.com/in/corporate/, visited Jan. 26, 2023) has patented a system for managing formal mentoring programs in U.S. Pat. No. 9,767,436 that provides a database for managing employee mentors in an internal company structure, but does not include procedural steps for what the mentor will actually do. There is no mention of different process steps for different phases of development nor metrics for each phase in a business or business owner's development. Branding of a mentoring process and then licensing that brand to multiple independent parties offering business mentoring services, implies, to the client, consistency in the processes used. Yet clients also need advice particular to their business and business state of maturity.

There is a need for an automated system that provides process steps for mentoring a business (owner) that are tailored to each particular business, but are consistently based depending upon a current development phase for the business.

### SUMMARY OF THE INVENTION

The invention addresses the shortcomings of prior art through, in a preferred embodiment, web based software and a database system that includes pre-selected process steps to be taken by a strategic business advisor or mentor and a mentee that are dependent upon the maturity or phase of the business and provided for each category of the business strategy, financial, personnel, management, and ongoing efficiency factors. A pre-selected set of metrics are also included to show performance highs and lows within a matrix of business phase and process category thereby provide a database of process steps and process results thereby allowing a measure of effectiveness of the pre-selected process steps. Scripts, that are tailored to the mentor and the mentee are provided that can be updated based upon performance results. The system includes a plurality of mentors offering services to a plurality of mentees and in a preferred embodiment shares performance data across such that process steps across categories can be updated to optimize performance results. Items in the matrix of parameters include those normal to business operations such as business financial results, product development cost and efficiency, and, delivery performance, and parameters hereto fore not included in prior business mentoring processes such as scripts to guide the mentor, and, efficiency properties of the mentored business. A “mentee” can be an individual be mentored or a larger part of the organization. Typically, however the mentee is a business owner or CEO who are in some way responsible for all aspects of a business' performance. The properties of the business are at least in part described by selecting a life cycle phase for the business owner from one of 5 categories from a one or two person business with a new product or service to a business owner that has scaled the business to an enterprise that has become self-managing through hiring, teaching and documenting procedures and promotion of a self-sustained structured management system. The system includes, for each of the categories of business stage, a scoring system specific to each business stage and libraries of process steps shown to improve scores. The system is intended to provide an organizer a means to manage a group of mentors serving a plurality of businesses at various stages of development. In one embodiment, results from a population of mentors each working independently with their own population of clients are centrally compiled to show effectiveness and allow for improvements to the coded procedures and metrics. The business mentoring process offers a structured approach to move a mentee from an early phase, perhaps a startup phase of a business through to a mature business that can operate efficiently and independently of the mentee's full attention. In a preferred embodiment the process is applied to businesses having achieved early success and now wishing to scale the business to an efficiently running operation including management team and business processes that can free the original founders to address future strategies for the business or new business opportunities rather than the day to day operation steps.

The specific examples are not intended to limit the inventive concept to the example application. Other aspects and advantages of the invention will be apparent from the accompanying drawings and detailed description.

### BRIEF DESCRIPTION OF THE DRAWINGS

FIG. 1 shows a block diagram of features of the invented mentoring system.

FIG. 2 shows an organization chart of the participants in the business mentoring system.

FIG. 3 shows a flow chart for processes that are typical of starting a mentoring service.

FIG. 4 shows block diagram for selecting a business phase for a new mentor or strategic advisor and for a new client for mentoring.

FIG. 5 shows a data collection scheme for a strategy phase of the process of FIG. 3.

FIG. 6 shows a block diagram of example components for a first, strategy category of the business mentoring process.

FIG. 7 shows a data collection scheme for a sustained execution phase of the process of FIG. 3.

FIG. 8 shows a flow chart for selecting and enrolling a new mentor or mentee client.

FIG. 9 shows a block diagram and flow chart for the mentoring process further included tasks selection for improvement.

FIG. 10 shows a block diagram for a matrix of phase and category of the business mentoring process.

FIG. 11 shows process flow for a first strategy category of the mentoring process.

FIG. 12 shows a process flow for a second, financial category, of the mentoring process.

FIG. 13 shows a block diagram for task selection and management in the mentoring process.

FIG. 14 shows a user interface for the task selection process.

### DETAILED DESCRIPTION OF THE INVENTION

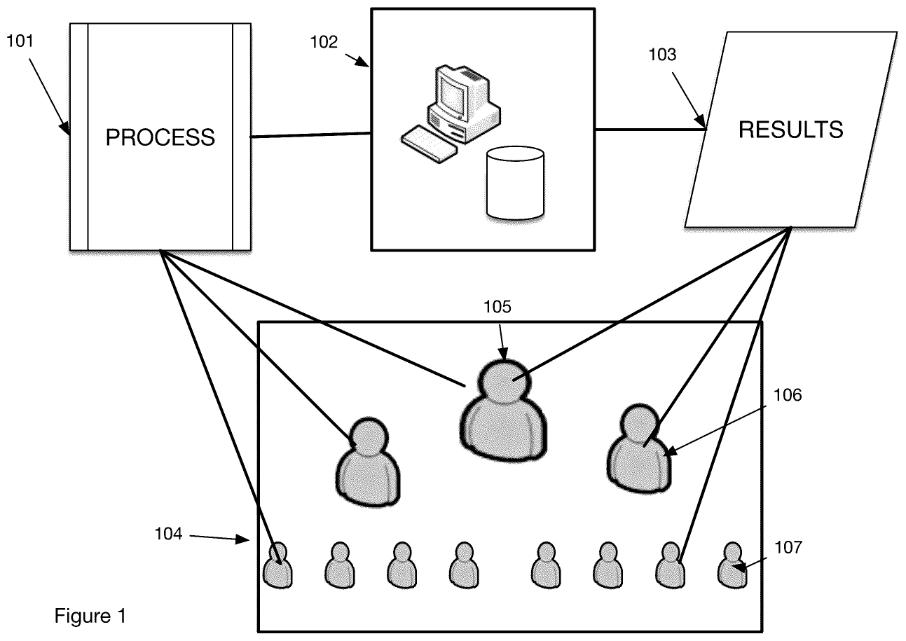

Referring to FIG. 1, the system includes process steps 101 that are encoded on a computing device 102. The computing device includes those functions and hardware as are known in the art, including user interface, networking capability and electronic storage. The computing device may include any form from a cellular phone, a tablet computer, personal computer to a distributed large scale computer systems. The computer system is also encoded to receive process step information and performance results 103. The Results include process steps scheduled, process steps completed, time stamps for each. The process steps include steps to automate and guide business mentoring steps in a population 104 that includes at least one organizer 105, at least one mentor 106 and a population of mentees 107. The mentees may include individuals such as business owners or sole proprietors, or business managers including top business managers such as CEOs. In general, the population of mentees 107 can be anyone responsible for a business performance. The Results 103 include business performance for all mentees, mentors, and organizers 105. The process 101 as encoded on the computing system 102 includes analysis of the results and amending the process steps to those found from the results 103 to improve the business performance most efficiently and in the shortest time. The fact that the results 103 are generated in a controlled environment increases the chance for finding improved process steps and even unexpected correlations from applying the controlled process steps across a population of organizers, mentors, and mentees.

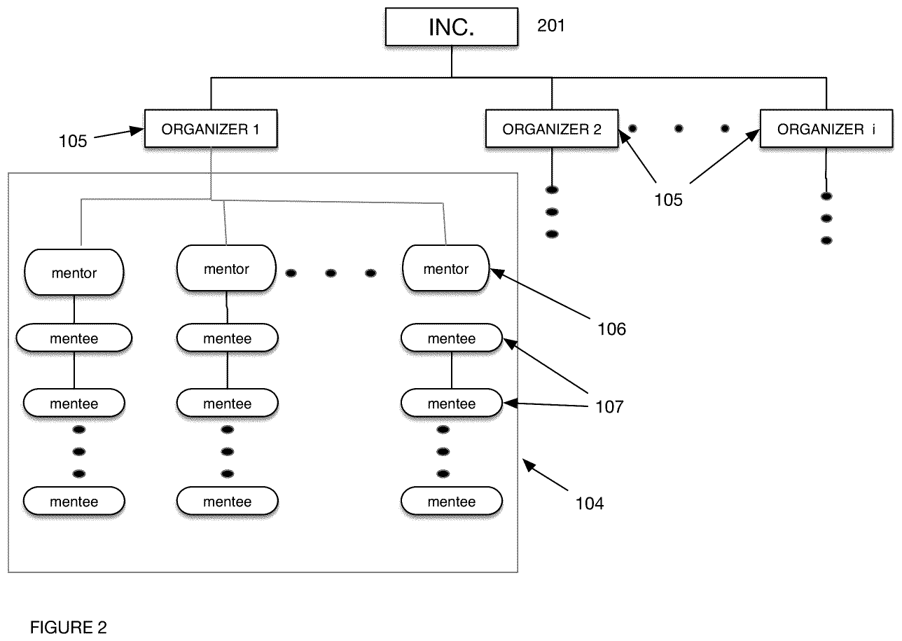

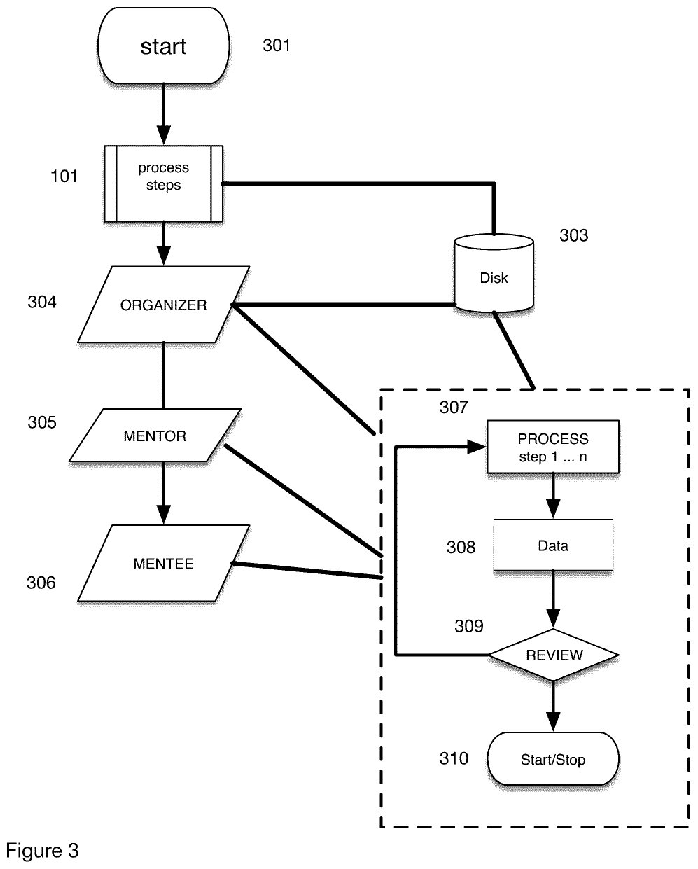

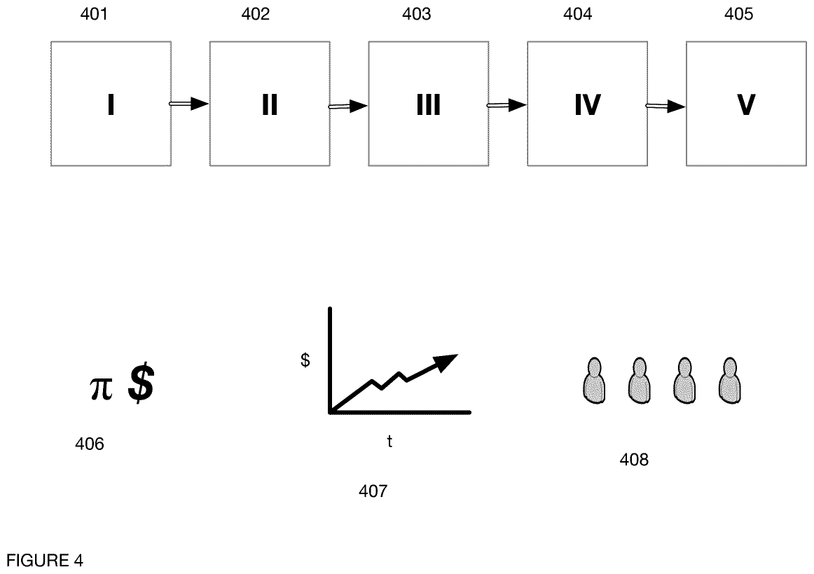

FIG. 2 shows an organization chart view of the users of the business mentoring process. In one embodiment a corporation or other entity 201 exists that offers mentoring services and include a plurality of organizers 105, each organizer procedurally responsible for a plurality of mentors or strategic advisors 106 and each mentor responsible for at least one mentee 107. The business mentoring process includes coded automation used by an organizer to assign mentors and mentees thereby creating the organized population 104. The organization may include corporation or other entity as a licensor of the process and the organizers 105 are each business mentor service providers that share data through the licensor corporation. In another embodiment the corporation 201 is a trade organization. Referring to FIG. 3 a flow chart of process steps, as encoded on a computing device, for creating the organized population 104 is shown. Process steps 101 includes more than a set of actions, but also includes database structures, metrics, steps for analysis of metrics, and, scripts to be used by mentors. The process is initiated 101 by a starting entity 201, as discussed above, responsible for performance of a group of organizers 105. Initiation includes defining a set of process steps 302 that are encoded on a computing device 102 and stored 303. Process steps 304 for an organizer includes preselecting both process steps and process parameters to be used in hiring a mentor 305 and accepting a mentee 306. In one embodiment the organizer 105 and mentor 106 are the same person performing multiple roles. The process steps 304 for the organizer further include selecting 306 at least one candidate to be a mentee. In one embodiment the selecting a new mentor 305 and selecting a mentee 306 includes generally a series of process steps 307 that include acquiring data 308 regarding the business maturity of the candidate mento/mentee, described in FIG. 4 below, and comparing 309 that data with preselected and stored parameters 303 and based upon that comparison either continuing with additional process steps 307 or stopping 310. Process steps 307 for evaluating and accepting a new mentor 305 and mentee 306 include evaluating the candidate as to business maturity 307, generating data 308 as to the business phase, comparing 309 the data to preselected criteria and if the candidate meets those criteria, continuing with additional process steps 307 such as: forming an agreement with the candidate as to the mentoring process to be used, forming a detailed assessment of the candidate selected to be a mentee and assigning the, now mentee, to the organization 104. The process steps completed 307, the data 308 and the results of the comparison 309 are all stored 303 in a database that associates the steps completed, data and results with both the candidate mentee, the mentor, and the organizer. In one embodiment the review 309 includes an assessment as to whether an alternative set of stored process steps 307 should be selected from a stored 303 set of process steps. The process steps in this selection and initiation process for a new mentee are further described in Figures that follow.

FIG. 4 shows diagrammatically features of an initial evaluation of a candidate mentee. The mentee is classified into one of five development phases 401-405. In one embodiment the classification is based upon: revenue and profit 406, revenue growth over time 407 and number of employees 408 and the development phase for a candidate mentee is selected on the basis of preselected values for each of these parameters. In an example of a preferred embodiment the development phase (I-V) of a candidate mentee is selected on the basis of pre-selected parameters as shown in Table 1.

TABLE 1

| PHASE: | I | II | III | IV | V |
|---|---|---|---|---|---|
| REVENUE ($) | >0 | >$10⁶ | >$10⁷ | >$10⁸ | >$10⁸ |
| PROFIT (π) | >0 | >$10⁵ | >$10⁶ | >$10⁷ | >$10⁷ |
| GROWTH | >20% | 20%-80% | 20%-80% | 10%-20% | 5%-15% |
| (d$/dt) | | | | | |
| EMPLOYEES | 1-3 | 3-10 | 10-40 | >100 | >200 |
| MANAGERS | 1-3 | 1-3 | 1-5 | >5 | >10 |

The goal of the business mentoring process is to move the mentee along from a current, less mature phase I for a business to phase V where the business is staffed and operating without day to day intervention of the senior management. Table 1 shows a truncated set of criteria for classifying a candidate business that are also applicable with an accepted mentee as they progress through the business mentoring process. In one embodiment of further assessment the coded business mentoring process includes a narrative description of the nature of the phases I-V as shown in Table 2.

TABLE 2
Phase Descriptions narrative.

| | |
|---|---|
| PHASE | You are operating solo or perhaps a partnership You rule |
| I | and run your domain You are getting your big idea out into |
| | the world so you can build a profitable company, impact |
| | many people and create a life based on your own terms. |
| | BUT, |
| | You, so far, are responsible for everything as you create, |
| | market, sell and implement. |
| | There is no bandwidth left and definitely no scaling up |
| | happening yet. |
| PHASE | |
| II | |
| | You are well into the 6-Figures of your company! You |
| | are continually improving your product service. You are |
| | getting clearer on your Target Market and beginning to |
| | delegate some of your tasks. |
| | BUT, |
| | You are still approving everything going in and out of |
| | your company This means choking the growth of your |
| | company. Still no scaling up happening yet! |
| PHASE | You are growing. Revenue is near or beyond 8 figures. |
| III | Fantastic! You are building teams, for example: Admin, |
| | Customer Service, Marketing. Sales. Finance, etc. You |
| | are seeing the potential for real growth. You are getting |
| | more clarity on your company's Strategic Vision. |
| | BUT, |
| | It often feels like you are running a circus because your |
| | team is not aligned with your vision. or you just don't |
| | have the right team in place. You have grown. but are still |
| | micro-managing everyone, spread way too thin, stuck in the |
| | weeds of your business instead of leading to the next phase. |
| PHASE | Way to go! You have moved from being a boss to the leader |
| IV | you are meant to be by building a collaborative team managed |
| | Company. You are empowering leaders on your team including |
| | current team-members or new recruits to step up and act. |
| | BUT, |
| | You have so much growth opportunities ahead of you and you |
| | still can't get your arms around them all. You are not |
| | firefighting or rescuing as much, but you still struggle with |
| | jumping back into the business and giving your 2 cents. This |
| | drags you back into the day to day, and away from planned |
| | strategic growth and scaling up your company. |
| PHASE | You have built a business asset that does not depend on you |
| V | to thrive! You have leaders in place and your business is |
| | truly scaling up. Your company valuation has increased |
| | because the business can run without you. You now have |
| | choices: You can bring on a CEO and move on to a next |
| | project, or . . . |
| | BUT, |
| | You may not have a clear Exit or Next-Chapter Action Plan? |
| | If you are planning to exit, do you have your next plan in |
| | place? Now is the time for this plan to be complete, or you |
| | could fall backwards instead or flying forward |

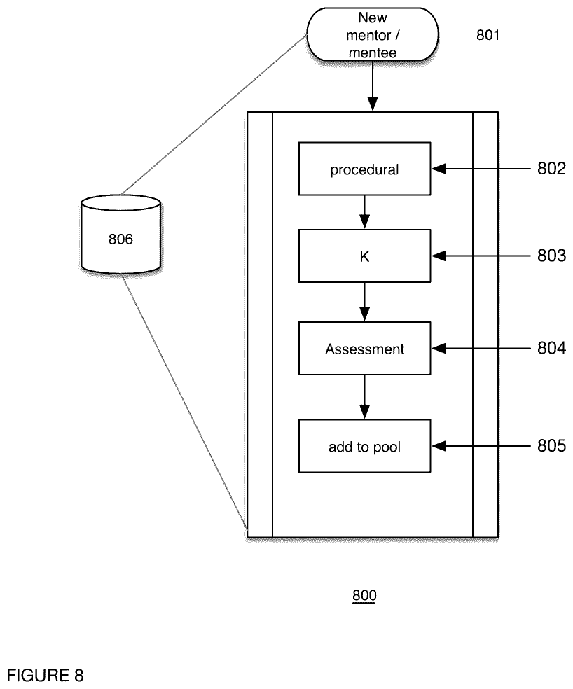

The process steps 306 include categorizing the candidate mentor and mentee into one of phase I-V based upon meeting all the criteria of revenue, profit, growth, number of employees and number of managers within the candidate's business. The process is the same for both candidate mentors and candidate mentees but the preselected criteria that define a business maturity phase 401-405 are not necessarily the same for a mentor as opposed to a mentee. An example difference is that the criteria and metrics for a candidate mentor would include their past experience as a business mentor and their plans for the mentoring business including their target clients, that they are offering. For example, if a candidate's business has little or no revenue or profit, revenue is growing greater than 20% and there are 1-3 employees, and 1-3 managers who are the 1-3 employees the candidate is in phase I, a startup phase. In another embodiment, the mentor or strategic advisor targets only business that have proven themselves through a minimal revenue, perhaps greater than $1 million in revenue and 20% margins and now are ready to scale up to a multinational business with 10 to 100× revenue and a mature staff that operates the business on a day to day basis to free the original organizers to move on to new opportunities. The pre-selected process steps defined at start 302 and shown as steps 307-309 for each of the organizer includes measurement steps as described and parameter criteria for selecting the selection process 306 includes pre-selected criteria for the phase classification of the candidate. An organizer sets 304 and stores 303 these preselected criteria for both acceptable mentors and acceptable mentees and applies the preselected criteria when hiring mentors step 305 and mentees at step 306. If a candidate mentee at the review step 309 is selected the further procedural process steps 307 are as shown in FIG. 8.

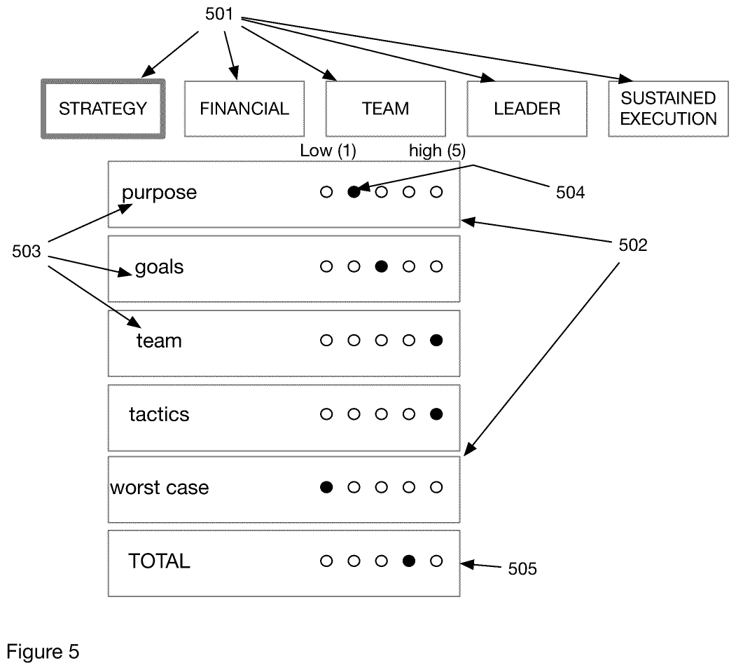

Each of the maturity levels include encoded steps to evaluate not just on the objective numbers in the examples of FIG. 4, but also on subject categories with prompts and scripts as shown in FIG. 5. A candidate is both evaluated, and does a self-evaluation, in each of subject categories 501. In a preferred embodiment categories 501 include strategy, financial team, leader, and sustained execution. FIG. 5 depicts an assessment script 502 for the Strategy category 501. As an example, candidate mentors and mentees are assessed and self-assess in response to questions 503 related to the candidate's purpose: Is the purpose of the business expressly stated, and, known by both employees within the business and to relevant third parties outside of the business. Here, for example, rated 504 at a 2. Similarly, Does the candidate business have expressly written goals, rated here as a 3. Is there a team in place to accomplish those goals, rated as a 5. Are tactics/action plans written for everyone on the team to meet the goals, again rated as a 5. And finally are worst case scenarios for the business, such as disasters, no sales, supply chain failures, etc. written with plans to overcome if they occur, here rated as a 1 or not completed. The total value 505, for the example a 4 provides an overall generalized score for the candidate in the strategy category. Criteria for accepting a candidate as either a mentor or a mentee are pre-selected for each of the categories 501. That is a candidate mentor or mentee results are reviewed 309 and must have a minimum overall score and a minimum score for individual measures 502 to be accepted as a mentor or as a new mentee into the business mentoring process (see FIG. 3). The results for the criteria for individual candidates are stored 303 and business results over time for both mentors and mentees are used to update the criteria and scripts 502 in the encoded process steps 101.

In another embodiment the strategy category of assessment further includes scripts for the development of a mind map 600 for the candidate mentor or mentee. Questions are scripted in the categories of team 601, purpose of the business 602, day to day operation procedures 603, personal goals for mentor and mentee 604 and questions related to customer 605 interaction collectively provided a future vision 606 for the candidate. Other scripted enquiries are included, but not labeled (awards, etc.). A criteria for acceptance of a candidate and for moving from phase I 401 through phase V 405 is an estimated level of completion of the future vision 606. The scripts 601-605 are updated in the coded business mentoring process, based upon stored actual business results for candidate mentors and mentees once mentored through the business mentoring process. Business results include the measured results for the business in each of the categories and for mentors the progress of their assigned mentees as they are mentored through the business mentoring process.

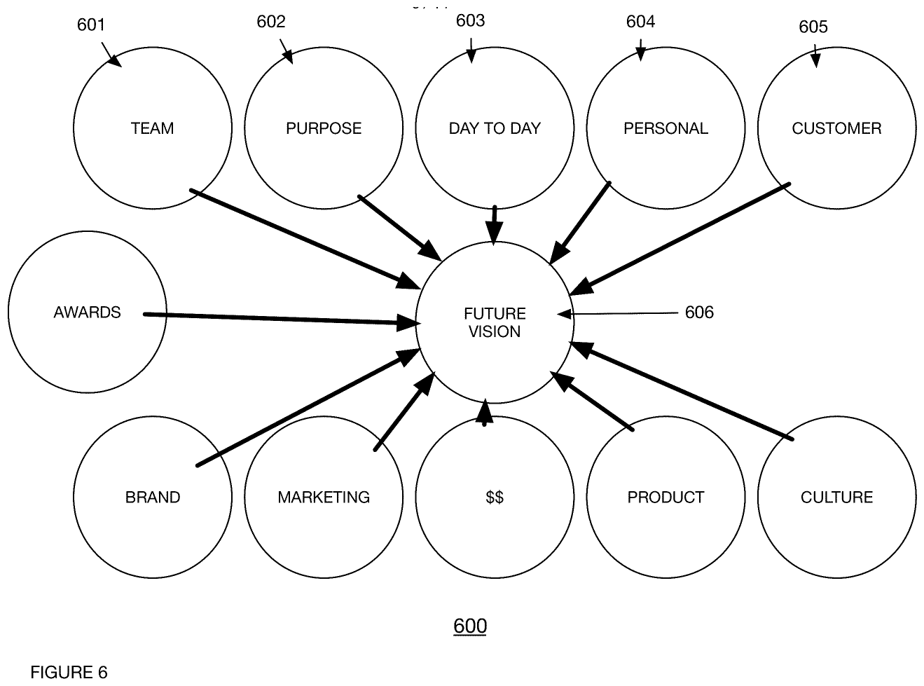

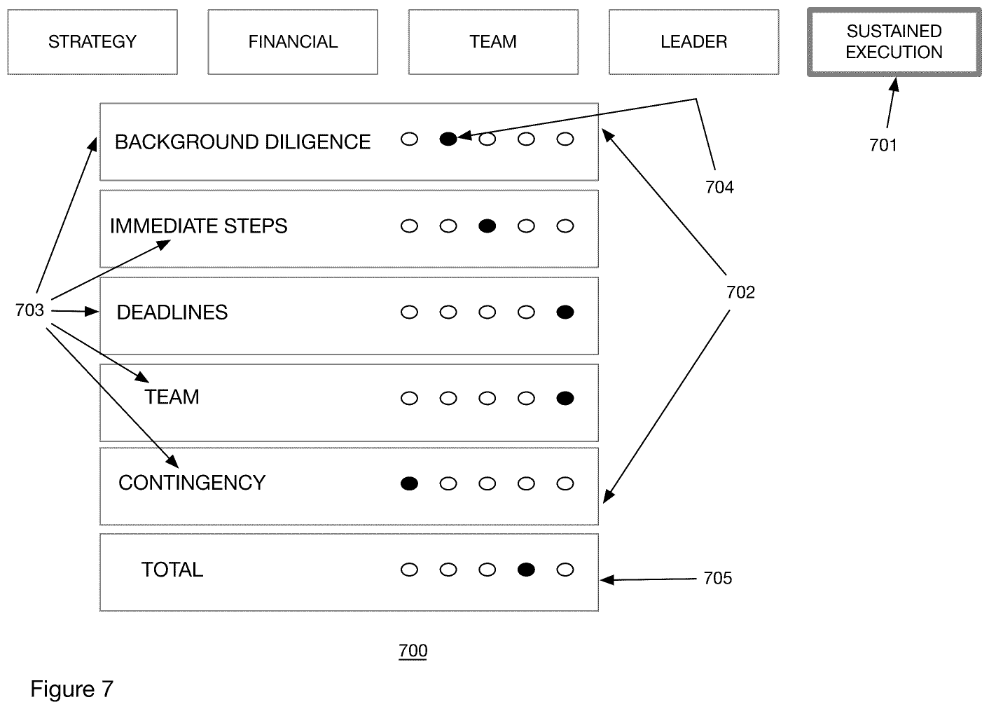

The coded business mentoring process includes measures and scripts to aid in numerically assessing the measures for each of the categories of strategy, financials, team, leader, and sustained execution. Example measures and scripts for the Strategy category are shown in FIGS. 5 and 6. FIG. 7 shows, in block diagram, coded measures and scripts 700 for the sustained execution category. FIG. 7 depicts an assessment script 702 including a scripted set of questions 703 for the sustained execution category 701. Candidate mentors and mentees are assessed and self-assess in response to questions 703 related to the candidate's maturity as to sustained execution 701: As an example, candidate mentors and mentees are assessed, and self-assess, in response to questions 703 related to the candidate's business diligence: Are written procedures in place and followed for the required background research for major business decisions, such as acquisitions or even selling of the business? Here, for example, the response rated 704 at a 2. Similarly, question 2 related to immediate steps: Does the candidate business have expressly next steps and Deadlines for completion of the Immediate Steps to move the company from level I novice to level V, successful business guru, rated here as a 3 and a 5 respectively. Is there a team in place to accomplish those goals, rated as a 5. Are contingency plans in place for worst case scenarios for the business? Rated here for example as a 1 or Lowest rating. The total value 705, for the example a 4 provides an overall generalized score for the candidate in the sustained execution 701 category. Criteria for accepting a candidate as either a mentor or a mentee are pre-selected for each of the categories 501. That is a candidate mentor or mentee results are reviewed 309 and must have a minimum overall score and a minimum score for individual measures 502 to be accepted as a mentor or as a new mentee into the business mentoring process (see FIG. 3). The results for the criteria for individual candidates are stored 303 and business results over time for both mentors and mentees are used to update the criteria and scripts 702 including scripted prompts 503, 703 in the encoded process steps 101. The particular preselected parameters and process steps are dependent upon the goals of both organizer, the mentor or strategic advisors and the target clients or mentees. These particular parameters can be wide ranging from a mentoring business that works with new business startups to one that caters to client businesses that have already achieved a minimal success and are ready to expand the business.

As shown in FIG. 8, a new mentor or mentee is selected 801 and a series of procedural steps 802 such as personal and payment information is entered. Again, general process steps 307-310 are as shown in FIG. 3. Each of the steps 802-805 include a set of process steps 307-310. As an example, the procedural 802 would include a step of obtaining personal information such as identity of the new mentee. This generates data 308 as to that identity which is compared 309 against criteria for authenticating identity and if successful processing is continued 307 and if not, the process is stopped 310. All the steps completed 307, the data 308 and the review 309 are stored 806. The further steps of accepting a new mentee include contractual agreement 803 between the Mentee and the organizer that the preselected process steps 303 are the service offered. If an agreement is reached, a further assessment 804 of the new member is completed. The further assessment includes a more detailed examination of further criteria for each of the business phases and assignment to a mentor. The mentor and the mentee then continue with pre-selected process steps, data generation and comparison of the data with preselected criteria for selection of further steps to be carried out to jointly guide the mentee from a first phase, such as phase I, through to phase V.

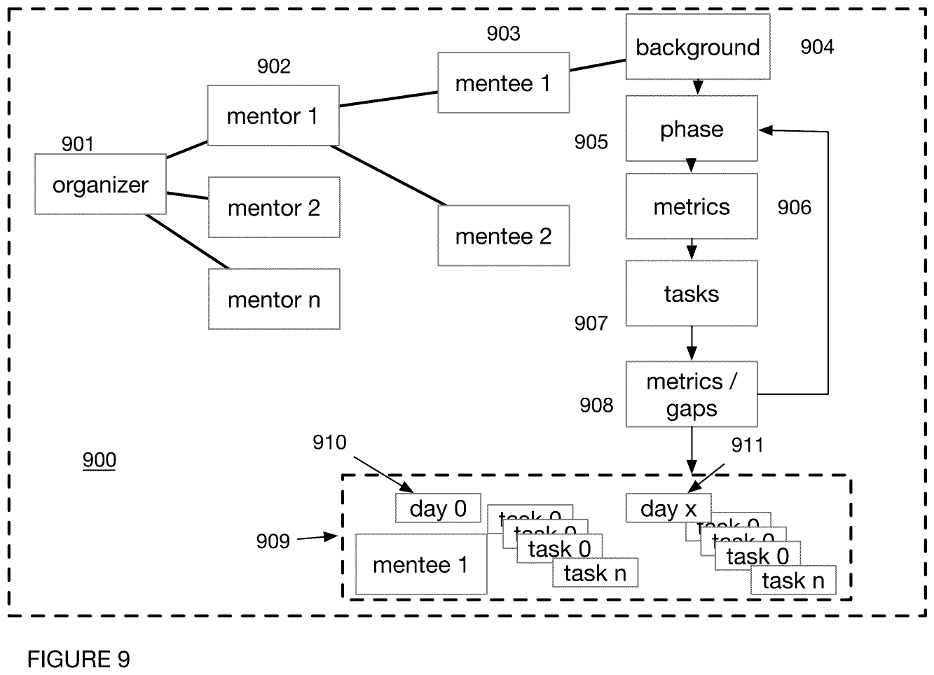

Referring to FIG. 9, the business mentoring system includes at least one organizer 901 who is responsible for managing a plurality of mentors 902, each mentor assigned at least one mentee 903, here only mentees for mentor 1 are shown. For each mentee the process flow includes generating background information 904 that identifies the mentee, an assessment 905 as discussed above that includes a development phase for the mentee, a set of metrics 906 that are appropriate for the phase, categorized into strategy, financial, etc. and results in a set of calculated gaps in desired performance for each category and each phase, a set of scheduled tasks 907 selected from a stored library of tasks known to be effective in reducing gaps for a subset of metrics where the gaps are larger than a preselected limit, performance of those scheduled tasks and reassessing the metrics and gaps 908 which leads back to an assessment of the phase 905 of the mentee. The loop 905-908 is continued until the mentee reaches a desired phase, typically phase V by growth, scale up and improvements in the mentees business and personal development. All steps and associated data 904-908 are stored in a database 909 that includes mentee information, a set of tasks committed to on day 0 910 through continuing the process loop 905-908 through day X 911. In one embodiment the business mentoring process 900 used by an organizer 901 to manage a group of mentors 902, each assigned a group of mentees 903 includes:
a. a phase evaluation process 905, having a set of phases to classify a business development for each mentee and each characterized by a set of performance metrics 906 including preselected goals for performance at each phase, and,
b. a set of scheduled tasks 907 preselected as known to produce improvements in each of the performance metrics, and,
c. each of the tasks and metrics categorized into one of strategy, financial, team building, leadership development and sustained business performance, and,
d. process steps that include the 1. phase evaluation process 905, 2. selecting metrics 906 characteristic of each phase and categorized, 3. selecting a set of scheduled categorized tasks 907, 4. performing the tasks, repeating steps 1-4 for each mentee until each mentee reaches a desired phase and performance on the metrics, and,
   wherein the tasks and metrics are preselected for a second mentee on the basis of business performance improvements of a first mentee.

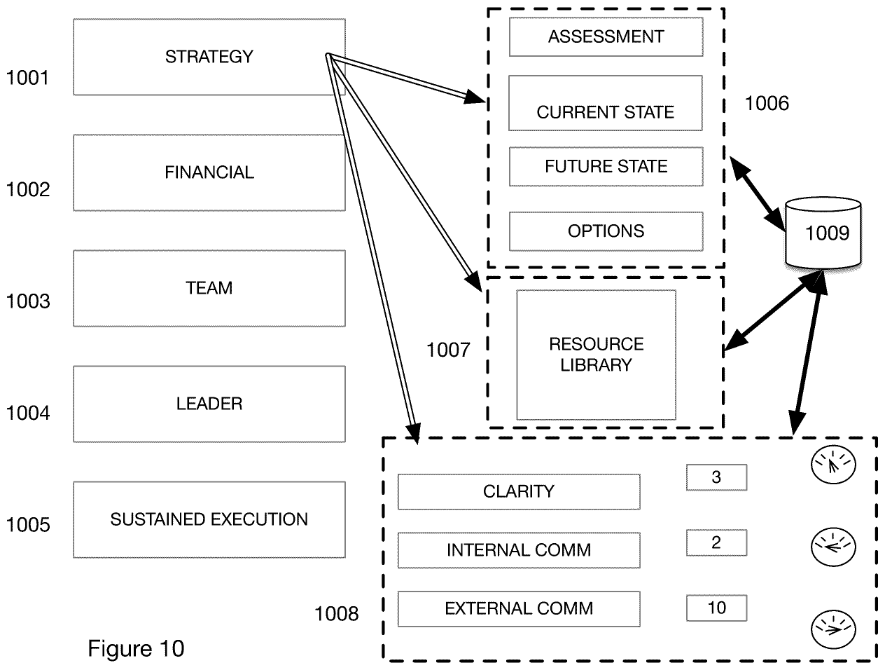

Referring now to FIG. 10, process steps are divided into categories of business strategy 1001, financial performance 1002, team development 1003, leadership development 1004, and sustained performance 1005. For each of the categories 1001-1005 there are a pre-selected set of process steps 1006, a resource library 1007 and performance metrics including estimates of current state 1008 all stored 1009. These three items 1006-1008 exist for each of the categories 1001-1005. Only those for the first category of strategy 1001 are shown. In this case a new mentee process steps would include a more detailed assessment as to business phase using metrics that are specific to each category 1001-1005 and, also specific to distinguish each phase. The items 1006-1008 are pre-programmed and stored 1009 with process steps, resources and metrics that are specific to both the category 1001-1005 and the phases I-V. The resource library includes business literature and additional process steps that may be used if particular metrics scores are low. In this case for the strategy category, metrics include clarity of the strategic vision, internal communication performance and external communication. A low score (shown as 2) on internal communication leads to select resources and further process steps known to positively affect this score.

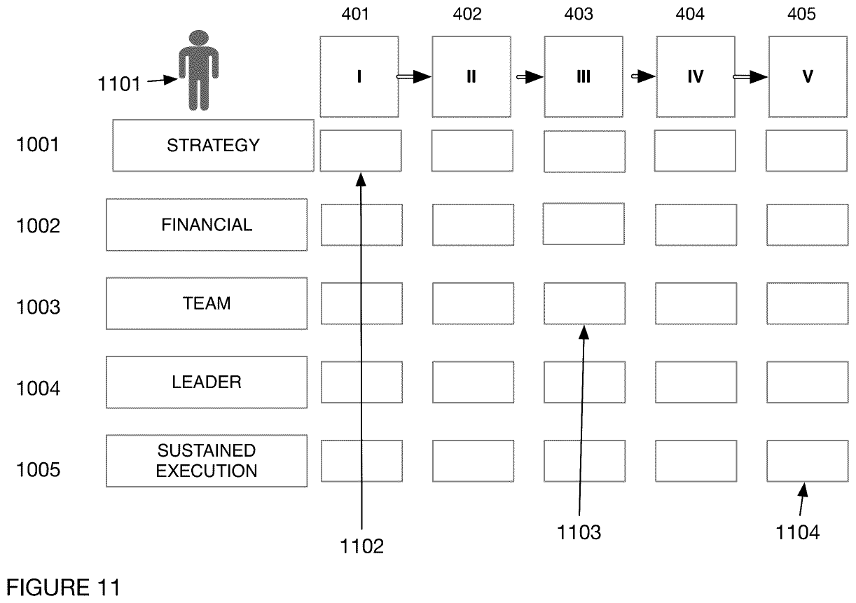

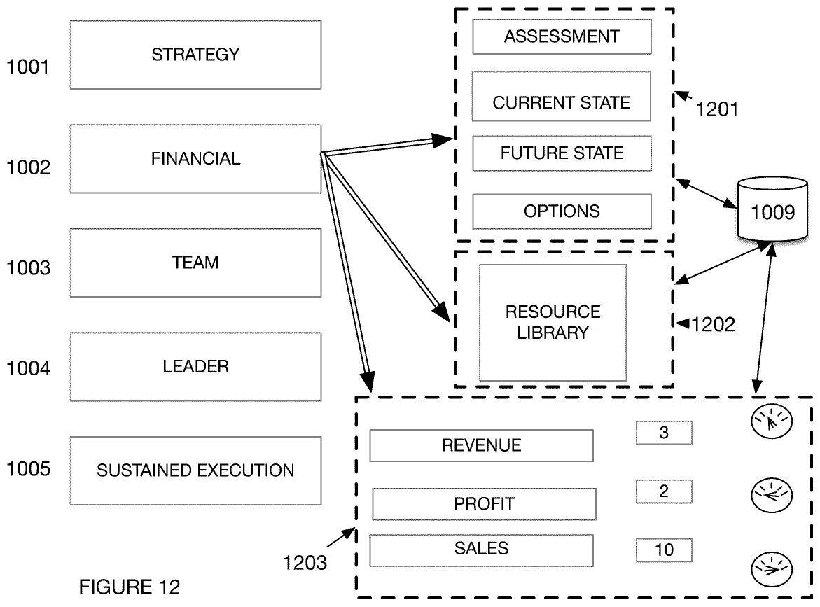

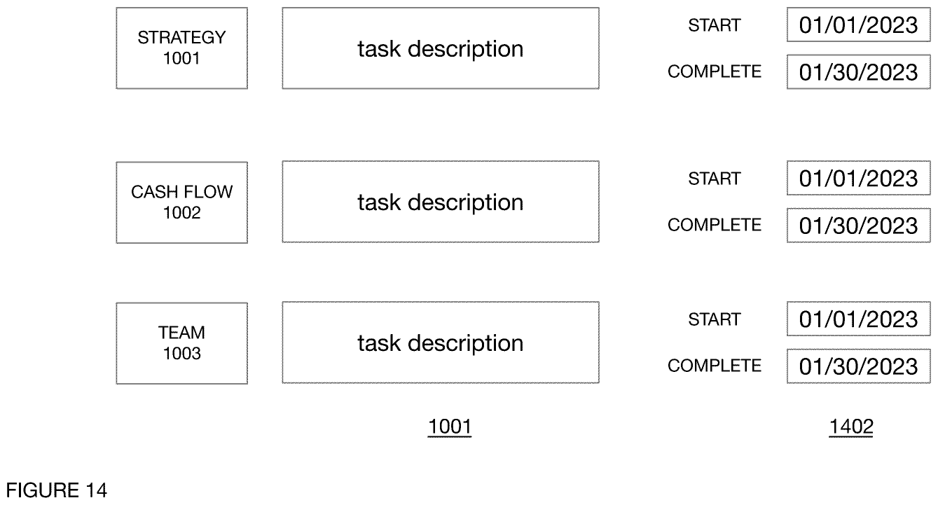

Referring now to FIG. 11, a 5×5 matrix of elements 1102-1104 (only 3 are labeled for clarity) that each includes mentoring steps, library of resources and metrics, as shown in FIGS. 12 and 14. The items are preselected for each phase 401-405 and for each category 1001-1005. For example, matrix element 1102 includes mentoring steps, a library of resources and metrics for developing a phase I mentee's strategy 1001. Likewise matrix element 1103 includes the same three preselected items to improve a phase III mentee's team development performance. Matrix element 1104 includes the same element for sustained execution or what's next for a mentee in phase V. Other matrix elements are populated similarly. In one embodiment the metrics for the categories of strategy, financial, etc. include rating scores as shown in Table 3. For each of the mentoring categories, i.e., Strategy, Financial, etc. there are the shown set of metrics. The mentees rate themselves and are rated by others such as their mentor, for each of the metrics, here shown as a rating on a scale of 1-10 with a goal of 10 for each. A gap is then the difference between 10 and the self-rating score. In another embodiment the gap is between the self-rating score and the mentor rating score of the mentee. For each gap value, and for each phase there are preselected steps known to improve scores for this metric and for each particular phase. The results are recorded in a database for each mentee. The storage includes a time/date and the improvement over time e.g., reducing the gap, for the steps selected is used to modify the preselected library of steps. Steps may be eliminated for lack of effect on the gap. Steps may be added or move up in rank for recommendations to mentors and their mentees based upon effectiveness in reducing the gap. The steps include scheduling a set of tasks to which the mentee commits to complete.

TABLE 3

| | |
|---|---|
| STRATEGY | CLARITY ON MY VISION (1-10): |
| | TEAM KNOWS THE VISION (1-10): |
| | CONSISTENTLY COMMUNICATING VISION (1-10): |
| FINANCIAL | REVENUE STATUS (1-10): |
| | PROFITS STATUS (1-10): |
| | MARKETING STATUS (1-10): |
| | SALES SYSTEM (1-10): |
| | ORGANIZATION OF FINANCES (1-10): |
| | CASH FLOW STATUS (1-10): |
| TEAM | TEAM POSITIONS FILLED (1-10): |
| | A-PLAYERS ON TEAM (1-10): |
| | DELEGATION (1-10): |
| LEADERSHIP | RUNNING A TEAM MANAGED COMPANY(1-10): |
| | LEADING MY TEAM (1-10): |
| | MONEY MINDSET (1-10): |
| | HANDLING CONFLICT (1-10): |
| | WORK/LIFE BALANCE (01-10): |
| | HEALTH STATUS (1-10): |
| | PERSONAL FULFILLMENT (1-10): |
| EXECUTION | TIME MANAGEMENT (1-10): |
| | SYSTEMS & PROCESSES (1-10): |
| | MEETING DEADLINES (1-10): |

FIG. 12 shows the equivalent the equivalent features as shown in FIG. 10 but for the financial category 1002. Process steps 1201, Resource library 1202 and metrics 1203 are specific to the financial category 1002. Referring now to FIG. 8, for each mentee the business mentoring process includes procedures as discussed above to classify the mentee as being in one of five 401-405 development phases. The mentee is being coached by a mentor using preselected and stored steps that are preselected as relevant to strategy 1001, Financials 1002, hiring or team building 1003, team leadership 1004 and sustained execution 1005.

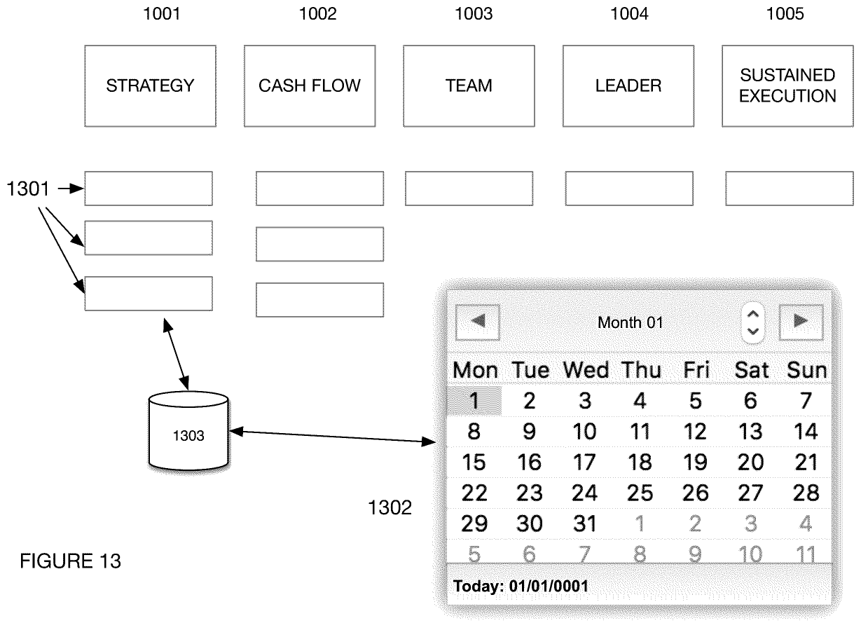

FIG. 13 shows aspects of a scheduling system for such tasks as included in the business mentoring system. for each of the categories 1001-1005 there are the set of selected tasks 1301. Each task includes a commitment to a completion date that is included in a calendar, and, as per all data is stored 1303.

FIG. 14 shows a block diagram of the data stored as related to tasks. Here for each category of mentoring steps 1001-1003 there are a set of tasks 1401, and each have start dates and completion dates 1402. This data is stored in association with a particular mentee and used generally to select tasks 1401 that have been shown by experience with other mentees to reduce gaps for particular metrics.

### SUMMARY

A business mentoring process for managing a plurality of mentors that includes preselected process steps and metrics is described. The process includes ongoing improvement of the process by creating a database of mentor and mentee information and time based evaluation of progress of each of a plurality of mentees as they complete preselected tasks and using the evaluation to select tasks to improve other mentee performance based upon performance improvements of a first mentee. The process enables a standardization of the mentoring process.

I claim:

1. A business mentoring process used by an organizer to manage a plurality of mentors, each assigned a plurality of mentees, the business mentoring process encoded on a computing device and including:
a. a phase evaluation process, having a set of phases to classify a business' development for each of the plurality of mentees and each characterized by a set of performance metrics including preselected goals for performance at each phase, and,
b. a set of scheduled tasks preselected as known to produce improvements in each of the performance metrics, and,
c. each of the tasks and metrics categorized into one of the categories of strategy, financial, team building, leadership development and sustained business performance and each of the scheduled tasks and metrics different for each of the phases and each of the categories, and,
d. the computing device programmed to prompt the plurality of mentors and the plurality of mentees to perform process steps that include the 1. phase evaluation process, 2. selecting metrics characteristic of each phase and categorized, 3. selecting a set of scheduled categorized tasks, 4. performing the tasks, repeating steps 1-4 for each of the plurality of mentees until each of the plurality mentee reaches a desired phase and a measured business performance on the metrics, and,
e. wherein the scheduled tasks, performance metrics, and, process steps are preselected for a second mentee on the basis of a correlation measured business performance of a first mentee with the preselected scheduled tasks, performance metrics and process steps used by the first mentee.

2. The business mentoring process of claim 1 wherein the computing device is further encoded to include written scripts to prompt the plurality of mentors.

3. The business mentoring process of claim 1 wherein the correlation of the measured business performance of the plurality of mentees with the scheduled tasks, performance metrics and process steps used at a first point in time by the plurality of mentors is used to update the scheduled tasks, performance metrics and process steps used by the plurality of mentors at a second point in time that is later than the first point in time.

4. The business mentoring process of claim 1 further including a plurality of organizers managing the plurality of mentors.
